(19) United States
(12) Patent Application Publication
(10) Pub. No.: US 2006/0035681 A1
(43) Pub. Date: Feb. 16, 2006

(54) Wireless communication terminal for controlling level of alarm using preference level and method thereof

(76) Inventor: Seung-Jin Oh, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/204,925

(22) Filed: Aug. 15, 2005

(30) Foreign Application Priority Data
Aug. 16, 2004 (KR) 10-2004-0064325

(51) Int. Cl. H04B 1/38; H04B 1/16; G08B 25/08

(52) U.S. Cl. 455/567; 455/200.1; 340/692

(57) ABSTRACT

A wireless communication terminal for controlling a level of an alarm to notice receipt of a call or a message by using a preference level and a method there are disclosed. The wireless communication terminal includes: a wireless transceiver for transmitting/receiving a call or a message; a memory for storing telephone numbers, preference levels per each of the stored telephone numbers, and messages; an output unit for outputting an alarm signal; a preference database for storing preference levels of telephone numbers; and a controller for identifying a telephone number of a received call or message, and controlling the level of the alarm based on the controlled level by using a preference level set based on the identified originator's telephone number according to a alarm level control mode.

### FIELD OF THE INVENTION

The present invention relates to a wireless communication terminal for controlling a level of an alarm to notice receipt of a call or a message by using a preference level and a method thereof; and, more particularly, to a wireless communication terminal for identifying an originator's telephone number of a received call or message and controlling a level of an alarm according to a preference level set according to the originator's telephone number in order to effectively inform the receipt of the call or the message.

### DESCRIPTION OF RELATED ARTS

A wireless communication terminal denotes a handheld terminal capable of transmitting/receiving voice, text, or moving picture through a wireless communication network, such as a mobile communication terminal, a personal communication service (PCS) phone, a personal digital assistant (PDA), a smart phone, a wireless local area network (LAN) terminal, and a next generation mobile communication terminal (IMT-2000).

Also, a message in the present invention represents a short message for a short message service (SMS), an enhanced message for an enhanced message service, and a multimedia message for a multimedia message service (MMS).

The most attractive advantage of a wireless communication terminal is mobility. Such an attractive advantage of the wireless communication terminal makes the number of wireless communication subscribers increased by geometric progression, and the wireless communication terminal becomes the necessity of life.

According to rapid development of the digital technologies, a multi-functional wireless communication terminal is introduced.

Such a multi-functional wireless communication terminal provides functions for receiving radio broadcasting signals, reproducing music files such as MP3 files, massaging, sensing a blood pressure, ultra-sound wave photographing, transmitting a text message, or transmitting a multimedia message.

Generally, a conventional wireless communication terminal informs the arrival of a message or the receipt of a call to a user by vibrating oneself or activating an alarm to reproduce a predetermined tune.

When informing the receipt of the message or the call, the conventional wireless communication terminal generally activates an alarm to reproduce a predetermined tune or a vibrator to being vibrating oneself based on a volume of the alarm or a level of the vibrator set by a user regardless of an originator's telephone number of the received call or the message.

That is, the conventional wireless communication terminal cannot distinctly inform the receipt of a call or a message according to an originator's telephone number.

### SUMMARY OF THE INVENTION

It is, therefore, an object of the present invention to provide a wireless communication terminal for identifying an originator's telephone number of a received call or message and controlling a level of an alarm according to a preference level set according to the originator's telephone number in order to effectively inform the receipt of the call or the message.

In accordance with an aspect of the present invention, there is also provided a wireless communication terminal for controlling a level of an alarm to notice receipt of a call or a message by using a preference level including: a wireless transceiver for transmitting/receiving a call or a message through a wireless communication network; a memory for storing telephone numbers, preference levels per each of the stored telephone numbers, and messages received at the wireless transceiver; an output unit for outputting an alarm signal to notice receipt of a call or a message; a preference database for storing preference levels corresponding to telephone numbers; and a controller for identifying an originator's telephone number of a received call or message when a call or a message is received, and controlling the level of the alarm for the output unit to output the alarm signal based on the controlled level by using a preference level set based on the identified originator's telephone number according to a alarm level control mode.

In accordance with another aspect of the present invention, there is also provided a method of controlling a level of an alarm to notice receipt of a call or a message by using a preference level in a wireless communication terminal including: setting a preference level corresponding to a telephone number according to a alarm level control mode; obtaining an originator's telephone number when a call or a message is received; identifying a alarm level control mode; and controlling a level of an alarm to notice receipt of a call or a message by using a preference level set based the obtained originator's telephone number according to the alarm level control mode.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating a wireless communication terminal for controlling a level of an alarm to notice receipt of a call or a message by using a preference level in accordance with a preferred embodiment of the present invention; and

FIG. 2 is a flowchart showing a method of controlling a level of an alarm to notice receipt of a call or a message by using a preference level in a wireless communication terminal in accordance with a preferred embodiment of the present invention.

### DETAILED DESCRIPTION OF THE INVENTION

Hereinafter, a wireless communication terminal for controlling a level of an alarm to notice receipt of a message or a call by using a preference level and a method thereof in accordance with a preferred embodiment of the present invention will be described in more detail with reference to the accompanying drawings.

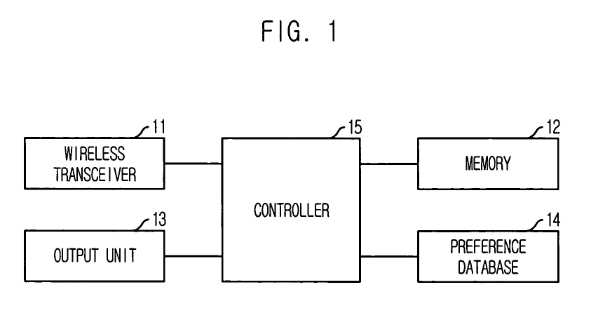

FIG. 1 is a block diagram illustrating a wireless communication terminal controlling a level of an alarm to notice receipt of a call or a message by using a preference level in accordance with a preferred embodiment of the present invention.

As shown in FIG. 1, the wireless communication terminal includes: a wireless transceiver 11 for receiving a call or a message, i.e., a short text message, an enhanced text message, and a multimedia message from an external device through a wireless communication network, and transmitting a call or a message to an external device through a wireless communication network; a memory 12 for storing telephone numbers, preference levels per telephone numbers used in a user-assign mode, and messages received through the wireless transceiver 11; an output unit for outputting an alarm signal to notice a receipt of a call or a message based on a predetermined level in response to a controller; a preference database 14 for storing preference levels corresponding to each of telephone numbers; a controller 15 for controlling a level of an alarm based on a preference level according to a control mode for the output unit 13 to output the alarm signal based on the controlled level after identifying an originator's telephone number when a call or a message is received.

If a control mode is set as a user-assign mode, the controller 15 controls a level of an incoming call/message notice alarm by using a pre-set preference level according to a telephone number for the output unit 13 to output the alarm signal within the controlled level in order to inform a receipt of a message or a call to a user. The incoming call/message notice alarm is an alarm to notice receipt of a call or a message to a user by reproducing a predetermined tune within a pre-set volume. And, the level of the alarm may be a volume of the incoming call/message notice alarm for the output unit 14 to reproduce a predetermined tune representing the incoming call/message notice alarm.

If a control mode is set as an automatic control mode, the controller 15 controls a level of an incoming call/message notice alarm by using a preference level in a preference database for the output unit 13 to output the alarm signal within the controlled level in order to inform a receipt of a message of a call to user. In the preference database, preference levels are classified according to each of the telephone numbers and the classified preference levels are stored.

Furthermore, the controller 15 identifies an originator's telephone number when a call or a message is received, controls a level of an incoming call/message notice alarm by using a pre-set preference level according to a telephone number for the output unit 13 to output the alarm signal within the controlled level in the user-assign mode, and controls a level of an incoming call/message notice alarm by using a preference level in a preference database for the output unit 13 to output the alarm signal within the controlled level within the controlled volume in the automatic control mode.

The preference levels set according to telephone numbers stored in the memory 12 are preference levels assigned to corresponding telephone numbers by a user. The user assigned preference levels are not changed until the user modifies the user assigned preference.

However, the preference levels stored in the preference database 14 are automatically updated by the controller 15 in the automatic control mode when a call or a message is transmitted or received. That is, the controller 15 updates the preference database when the message is receives or transmitted. Also, the controller 15 updates the preference database after hanging-up the call when a call is received or transmitted.

In the present invention, the level of the incoming call/message notice alarm is controlled by using a preference level such as the number of calls, the number of transmitting a message, the number of receiving a message, a call duration, the number of call returns. The number of calls includes calls having a call duration longer than a first predetermined call duration or shorter than a second predetermined time.

Each of the preference levels is set according to a corresponding telephone number. If received calls or received messages do not have information of an originator's telephone number, an identification or a predetermined number is assigned to all of them regardless of originator's telephone number and a predetermined preference level is assigned to all of them. Also, a preference level may be updated by setting a specific time zone and assigning a weight to an originator's telephone number when a call or a message is received during the set specific time zone.

Also, the controller 15 may update the preference database 14 by using preference levels of a predetermined period. For example, if the predetermined period is set as one month, the controller 15 controls a volume of an incoming call/message notice alarm by using preference levels accumulated until the previous day at a first month in the automatic control mode. After the first month, the controller 15 deletes the preference level stored in 1^{st} day of last month, and accumulates a preference level at 1^{st} day of the current month for maintaining the database having 30 day accumulated preference levels in the automatic control mode.

By using the preference levels described above, the controller 15 may control the level of the incoming call/message notice alarm in various ways. That is, an output level of the output unit 13 can be dynamically controlled based on the preference database 14.

As an example, controlling the level of the incoming call/message notice alarm by using the number of receiving messages according to an originator's telephone number during a week among the various preference levels will be explained. It assumes that the output unit 13 reproduces a predetermined tune with 5 volume levels, from 5 (MIN) to 10 (MAX), for the incoming call/message notice alarm.

If the number of receiving messages from a predetermined originator is smaller than 2, the controller 15 may control a volume level of an incoming call/message notice alarm as 5, and output an activation signal to the output unit 13 to reproduce a predetermined tune of the incoming call/message notice alarm with the volume level 5. If the number of receiving messages from a predetermined originator is in a range from 3 to 5, the controller 15 may control a volume level of an incoming call/message notice alarm as 6, and output an activation signal to the output unit 13 to reproduce a predetermined tune of the incoming call/message notice alarm with the volume level 6. If the number of receiving messages from a predetermined originator is in a range from 6 to 9, the controller 15 may control a volume level of an incoming call/message notice alarm as 8, and output an activation signal to the output unit 13 to reproduce a predetermined tune of the incoming call/message notice alarm with the volume level 6. Also, if the number of receiving messages from a predetermined originator is larger than 10, the controller 15 may control a volume level of an incoming call/message notice alarm as 10, and output an activation signal to the output unit 13 to reproduce a predetermined tune of the incoming call/message notice alarm with the volume level 10.

As another example, controlling the volume of the incoming call/message notice alarm by using the number of receiving messages and the number of transmitting message according to the originator's telephone number during a week among the various preference levels will be explained. It assumes that the output unit 13 reproduces a predetermined tune with 5 volume levels from 5 (MIN) to 10 (MAX) for the incoming call/message notice alarm.

If the number of receiving messages from a predetermined originator is smaller than 2 and the number of transmitting messages send to same originator is smaller than 2, the controller 15 may control a volume level of an incoming call/message notice alarm as 5, and output an activation signal to the output unit 13 to reproduce a predetermined tune of the incoming call/message notice alarm with the volume level 5. If each of the number of receiving messages and the number of transmitting message is in a range from 3 to 5, the controller 15 may control a volume level of an incoming call/message notice alarm as 6, and output an activation signal to the output unit 13 to reproduce a predetermined tune of the incoming call/message notice alarm with the volume level 6. If each of the number of receiving messages and the number of transmitting message is in a range from 6 to 9, the controller 15 may control a volume level of an incoming call/message notice alarm as 8, and output an activation signal to the output unit 13 to reproduce a predetermined tune of the incoming call/message notice alarm with the volume level 8. Also, if both of the number of receiving messages and the number of transmitting message is larger than 10, the controller 15 may control a volume level of an incoming call/message notice alarm as 10, and output an activation signal to the output unit 13 to reproduce a predetermined tune of the incoming call/message notice alarm with the volume level 10.

As still another example, controlling the volume of the incoming call/message notice alarm by using the number of receiving messages from a predetermined originator and a total call duration of the same originator during a week among the various preference levels will be explained. It assumes that the output unit 13 reproduces a predetermined tune with 5 volume levels from 5 (MIN) to 10 (MAX) for the incoming call/message notice alarm.

If the number of receiving messages from the predetermined originator is smaller than 2 and the total call duration of the same originator is shorter than 10 minutes, the controller 15 may control a volume level of an incoming call/message notice alarm as 5, and output an activation signal to the output unit 13 to reproduce a predetermined tune of the incoming call/message notice alarm with the volume level 5. If the number of receiving messages from the predetermined originator is in a range from 3 to 5 and the total call duration of the same originator is in a rage from 10 minutes to 30 minutes, the controller 15 may control a volume level of an incoming call/message notice alarm as 6, and output an activation signal to the output unit 13 to reproduce a predetermined tune of the incoming call/message notice alarm with the volume level 6. If the number of receiving messages from the predetermined originator is in a range from 6 to 9 and the total call duration of the same originator is in a rage from 30 minutes to 1 hour, the controller 15 may control a volume level of an incoming call/message notice alarm as 8, and output an activation signal to the output unit 13 to reproduce a predetermined tune of the incoming call/message notice alarm with the volume level 8. Also, if the number of receiving messages is larger than 10 and the total call duration is longer than 1 hour, the controller 15 may control a volume level of an incoming call/message notice alarm as 10, and output an activation signal to the output unit 13 to reproduce a predetermined tune of the incoming call/message notice alarm with the volume level 10.

As described above, the volume level of the incoming call/message notice alarm can be controlled in various ways by combining the preference levels.

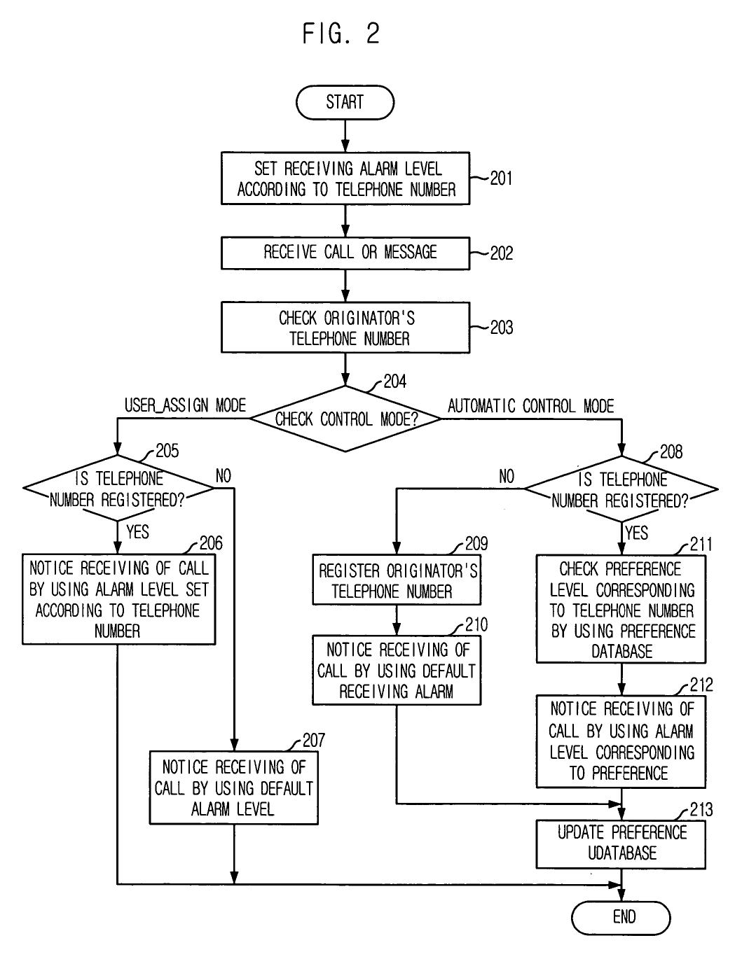

FIG. 2 is a flowchart showing a method of controlling a level of an alarm to notice receipt of a call or a message by using a preference level in a wireless communication terminal in accordance with a preferred embodiment of the present invention.

Referring to FIG. 2, at first, a user sets preference levels per each of telephone numbers at step S201. The preference levels set in step S201 includes preference levels used in the user-assign mode and preference levels used in the automatic control mode.

After setting the preference levels, an originator's telephone number is identified when a call or a message is received at steps S202 and S203.

Then, it determines whether a control mode is the user-assign mode or the automatic control mode at step S204.

If the control mode is the user-assign mode at step S204, it determines whether an originator's telephone number of the received call or message is registered in the memory 12 or not at step S205. That is, it determines whether the originator's telephone number is stored in the memory or not.

If the originator's telephone number is registered in the memory 12 at step S205, the output unit 13 outputs an alarm signal representing the incoming call/message notice alarm based on a level of the incoming call/message notice alarm set according to a preference level of the originator's telephone number at step S206. If the originator's telephone number is not registered in the memory 12 at step S205, the output unit 13 outputs an alarm signal representing the incoming call/message notice alarm based on a default level at step S207.

Hereinbefore, a method of controlling a level of an incoming call/message notice alarm in a wireless communication terminal when the control mode is set as the user-assign mode was described.

Hereinafter, a method of controlling a level of an incoming call/message notice alarm in a wireless communication terminal when the control mode is set as the automatic control mode will be described.

If the control mode is the automatic control mode at step S204, it determines whether the originator's telephone number is stored in the memory 12 or not at step S208.

If the originator's telephone number is not stored in the memory 12 at step S208, the originator's telephone number which is identified in the step S203 is registered at step S209. That is, the originator's telephone number is stored in the memory 12.

After storing, the output unit 13 outputs an alarm signal representing the incoming call/message notice alarm based on the default level at step S210.

After reproducing, the preference database 14 is updated at step S213.

On contrary, if the originator's telephone number is registered at step S208, it identifies a preference level corresponding to the originator's telephone number by using the preference database 14 at step S211.

Then, the output unit 13 outputs the alarm signal representing the incoming call/message notice alarm based on a level of the incoming call/message notice alarm corresponding to the preference level of the originator's telephone number at step S212.

After then, the preference database 14 is updated at step S213.

As described above, the level of the incoming call/message notice alarm is controlled in the present invention by identifying an originator's telephone number of the received message or call, determining a preference level set according to the originator's telephone number, and controlling the level of the incoming call/message notice alarm by using the determined preference level according to the control mode. Therefore, receipt of message or call can be effectively noticed to a user.

Furthermore, the level of the incoming call/message notice alarm is controlled in the present invention by identifying an originator's telephone number when a call or a message is received, controlling the level of the incoming call/message notice alarm using a preference level pre-set according to the originator's telephone number by a user in a user-assign mode, or controlling a level of the incoming call/message notice alarm according to a preference level in a preference database in an automatic control mode. Therefore, receipt of message of call can be distinctly informed to a user according to the preference levels.

The present application contains subject matter related to Korean patent application No. KR 2004-0064325, filed with the Korean patent office on Aug. 16, 2004, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A wireless communication terminal for controlling a level of an alarm to notice receipt of a call or a message by using a preference level, the wireless communication terminal comprising:
a wireless transceiver for transmitting/receiving a call or a message through a wireless communication network;
a memory for storing telephone numbers, preference levels per each of the stored telephone numbers, and messages received at the wireless transceiver;
an output unit for outputting an alarm signal to notice receipt of a call or a message;
a preference database for storing preference levels corresponding to telephone numbers; and
a controller for identifying an originator's telephone number of a received call or message when a call or a message is received, and controlling the level of the alarm for the output unit to output the alarm signal based on the controlled level by using a preference level set based on the identified originator's telephone number according to a alarm level control mode.

2. The wireless communication terminal as recited in claim 1, wherein the controller uses a preference level stored in the memory for controlling the level when the alarm level control mode is a user-assign mode.

3. The wireless communication terminal as recited in claim 1, wherein the controller uses a preference level of the originator's telephone number stored in the preference database for controlling the level when the control mode is an automatic control mode, and updates the preference database.

4. The wireless communication terminal as recited in claim 1, wherein the controller uses a preference level stored in the memory for controlling the level when the alarm control mode is a user-assign mode, and the controller uses a preference level of the originator's telephone number stored in the preference database and updates the preference database when the alarm level control mode is an automatic control mode.

5. The wireless communication terminal as recited in claim 3, wherein when a message or a call having no originator's telephone number is received, the controller assigns a predetermined identification to the received message or the received call regardless of the originator's telephone number and information of the received message or call with the assigned predetermined identification is stored in the preference database.

6. The wireless communication terminal as recited in claim 3, wherein the controller updates a preference level by assigning a weight to a corresponding originator's telephone number when a call or a message is transmitted or received in a predetermined time zone.

7. The wireless communication terminal as recited in claim 3, wherein the preference level includes the number of calls, the number of transmitting a message, the number of receiving a message, a call duration, the number of call returns, herein the number of calls includes calls having a call duration longer than a first predetermined duration or shorter than a second predetermined duration.

8. A method of controlling a level of an alarm to notice receipt of a call or a message by using a preference level in a wireless communication terminal, the method comprising:
setting a preference level corresponding to a telephone number according to a alarm level control mode;
obtaining an originator's telephone number when a call or a message is received;
identifying a alarm level control mode; and
controlling a level of an alarm to notice receipt of a call or a message by using a preference level set based the obtained originator's telephone number according to the alarm level control mode.

9. The method as recited in claim 8, wherein in the controlling a level of an alarm, the level is controlled by using a pre-set preference level when an alarm level control mode is a user-assign mode.

10. The method as recited in claim 8, wherein in the controlling a level of an alarm, the level is controlled by using a preference database and the preference database is updated after controlling the level when an alarm level control mode is an automatic control mode.

11. The method as recited in claim 8, wherein in the controlling a level of an alarm, the level is controlled by using a pre-set preference level when an alarm level control mode is a user-assign mode, and the level is controlled by using a preference database and the preference database is updated after controlling the level when an alarm level control mode is an automatic control mode.

12. The method as recited in claim 10, wherein the controlling a level of an alarm in the automatic control mode includes:
determining whether an originator's telephone number is registered or not when the alarm level control mode is the automatic control mode;
registering the originator's telephone if the originator's telephone number is not registered, and an alarm signal is outputted based on a default level; and
determining a preference level of the originator's telephone number by using the preference database if the originator's telephone number is registered; and
outputting the alarm signal based on the determined preference level.

13. The method as recited in claim 12, wherein in the registering the originator's telephone, when a message or a call having no originator's telephone number is received, a predetermined identification is assigned to the received message or the received call regardless of the originator's telephone number and information of the received message or call with the assigned predetermined identification is stored.

14. The method as recited in claim 10, wherein the preference level includes the number of calls, the number of transmitting a message, the number of receiving a message, a call duration, the number of call returns, herein the number of calls includes calls having a call duration longer than a first predetermined duration or shorter than a second predetermined duration.
